(19) United States
(12) Patent Application Publication
(10) Pub. No.: US 2004/0042171 A1
(43) Pub. Date: Mar. 4, 2004

(54) Electronic apparatus having display unit containing radiator radiating heat of heat generating component

(76) Inventors: Tomonao Takamatsu, Tokyo (JP); Katsumi Hisano, Kashiwa-shi (JP); Hideo Iwasaki, Kawasaki-shi (JP); Kentaro Tomioka, Sayama-shi (JP)

Correspondence Address: PILLSBURY WINTHROP, LLP, P.O. BOX 10500, MCLEAN, VA, 22102, US

(21) Appl. No.: 10/425,027

(22) Filed: Apr. 29, 2003

(30) Foreign Application Priority Data
Apr. 30, 2002 (JP) 2002-128821

(51) Int. Cl. G06F 1/20; F24H 3/02

(52) U.S. Cl. 361/687; 361/695; 361/702; 165/104.33; 165/80.3; 165/121; 415/177

(57) ABSTRACT

An electronic apparatus is provided with a main body having a heat generating component, a heat receiving portion thermally connected to the heat generating component, a display unit supported by the main body and having a display panel, a heat radiating portion contained in the display unit, and a circulation path which circulates a liquid refrigerant between the heat receiving portion and the heat radiating portion. The display unit contains a fan. The fan supplies cooling air to the heat radiating portion to cool the heat radiating portion by force.

### CROSS-REFERENCE TO RELATED APPLICATIONS

This application is based upon and claims the benefit of priority from the prior Japanese Patent Application No. 2002-128821, filed Apr. 30, 2002, the entire contents of which are incorporated herein by reference.

### BACKGROUND OF THE INVENTION

1. Field of the Invention

The present invention relates to a liquid-cooled electronic apparatus which cools a heat generating component, such as a microprocessor, by using a liquid refrigerant, in particular, to a structure for enhancing performance for radiating heat of a heated refrigerant.

2. Description of the Related Art

With the increase in the processing speed and functions of computers, the amount of heat generated by microprocessors, which are used for notebook portable computers, during operation is rapidly increasing. Therefore, it is feared that conventional air-cooled cooling systems using an electric fan will not be able to deal with an increased heat-radiation amount of microprocessors, and are insufficient in, or reach the limit of, performance of cooling a microprocessor.

As a countermeasure, portable computers mounting a liquid-cooled cooling system which absorbs heat of a microprocessor by using a cooling liquid having a specific heat far greater than that of air have been tried.

U.S. Pat. No. 5,383,340 discloses a portable computer with a liquid-cooled cooling system. The portable computer has a computer main body and a display unit. The computer main body contains a microprocessor which generates heat. The display unit contains a display panel, and is rotatably supported by the computer main body.

The cooling system has an evaporator, a condenser and a conduit for circulating the coolant. The evaporator is contained in the computer main body, and thermally connected to the microprocessor. The condenser is contained in the display unit. The conduit connects the evaporator with the condenser, to transfer the coolant evaporated in the evaporator to the condenser. The coolant transferred to the condenser is liquefied by means of heat exchange therein, and returns to the evaporator through the conduit. Therefore, the coolant repeatedly circulates between the evaporator and the condenser, and thereby heat of the microprocessor is radiated to the outside of the display unit through the condenser.

According to the liquid-cooled cooling system, the heat of the microprocessor can be efficiently transferred to the condenser through the flow of the coolant. This enhances the performance for cooling the microprocessor in comparison with a conventional common air-cooled cooling system.

The condenser contained in the display unit comprises a pipe through which the coolant flows, and a heat radiating plate thermally connected to the pipe. When a heated coolant is introduced into the condenser, the heat of the coolant is conducted from the pipe to the heat radiating plate while the coolant flows through the pipe. The heat conducted to the heat radiating plate is diffused to the heat radiating plate, and thereafter radiated from the surface of the plate.

However, the condenser only radiates the heat of the coolant by means of spontaneous air cooling caused by diffusion of the heat from the pipe to the heat radiating plate. Therefore, supposing that the surface temperature of the display unit containing the condenser should not exceed, for example, 60° C., the heat-radiation amount of the condenser is at best less than 20 W.

Microprocessors of portable computers are expected to be further improved in performance in the near future, thus the amount of heat generated by the microprocessors will rapidly increase in parallel. Therefore, even if a liquid-cooled cooling system is adopted, the radiating power required of a condenser will reach tens of watts, and a problem will rise that a current condenser is insufficient in radiating power.

### BRIEF SUMMARY OF THE INVENTION

The embodiment of the present invention is to obtain an electronic apparatus which can efficiently radiate heat transferred from a heat generating component to a radiating part, and can enhance the performance for cooling the heat generating component.

An electronic apparatus according to an embodiment of the present invention comprises: a main body having a heat generating component; a heat receiving portion thermally connected to the heat generating component; a display unit supported by the main body and having a display panel; a heat radiating portion contained in the display unit; and a circulation path which circulates a liquid refrigerant between the heat receiving portion and the heat radiating portion. The display unit contains a fan. The fan supplies cooling air to the heat radiating portion to cool the heat radiating portion.

In such a structure, the heat of the heat generating component is absorbed by the refrigerant in the heat receiving portion. The refrigerant heated by heat exchange in the heat receiving portion is transferred to the heat radiating portion through the circulation path. The heat of the heat generating component absorbed by the refrigerant is conducted to the heat radiating portion in the process in which the refrigerant flows through the heat radiating portion, and radiated from the surface of the heat radiating portion. The heat radiating portion is cooled by force by contact with cooling air sent from the fan. This improves radiating performance of the heat radiating portion, and enables efficient radiation of the heat of the heat generating component.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a portable computer in a first embodiment of the present invention, showing a positional relation among a heat receiving head, radiator, refrigerant circulation path, centrifugal pump, and electric fan.

FIG. 2 is a perspective view of the portable computer in the first embodiment of the present invention, showing the state where a display unit has been rotated to an open position.

FIG. 3 is a cross-sectional view of the portable computer in the first embodiment of the present invention, showing a positional relation among the heat receiving head, radiator, refrigerant circulation path, centrifugal pump, and electric fan.

FIG. 4 is a cross-sectional view of the portable computer in the first embodiment of the present invention, showing a positional relation between a semiconductor package and the heat receiving head.

FIG. 5 is a cross-sectional view of the heat receiving head thermally connected with the semiconductor package, in the first embodiment of the present invention.

FIG. 6 is a cross-sectional view of the portable computer in the first embodiment of the present invention, showing a positional relation between the electric fan and a second housing of the display unit.

FIG. 7 is a cross-sectional view taken along line F7-F7 of FIG. 3.

FIG. 8 is a cross-sectional view taken along line F8-F8 of FIG. 3.

FIG. 9 is a perspective view of a portable computer in a second embodiment of the present invention, showing a positional relation among a heat receiving head, radiator, refrigerant circulation path, centrifugal pump, and electric fan.

FIG. 10A is a cross-sectional view taken along line F10A-F10A of FIG. 9.

FIG. 10B is a cross-sectional view taken along line F10B-F10B of FIG. 9.

FIG. 11 is a cross-sectional view of a radiator according to a third embodiment of the present invention.

FIG. 12 is a cross-sectional view of a portable computer in a fourth embodiment of the present invention, showing a positional relation among a heat receiving head, radiator, refrigerant circulation path, centrifugal pump, and electric fan.

FIG. 13 is a cross-sectional view of a portable computer in a fifth embodiment of the present invention, showing a positional relation among a heat receiving head, radiator, refrigerant circulation path, and centrifugal pump.

FIG. 14 is a cross-sectional view of a portable computer in a sixth embodiment of the present invention, showing a positional relation among a heat receiving head, radiator, refrigerant circulation path, centrifugal pump, and electric fan.

### DETAILED DESCRIPTION OF THE INVENTION

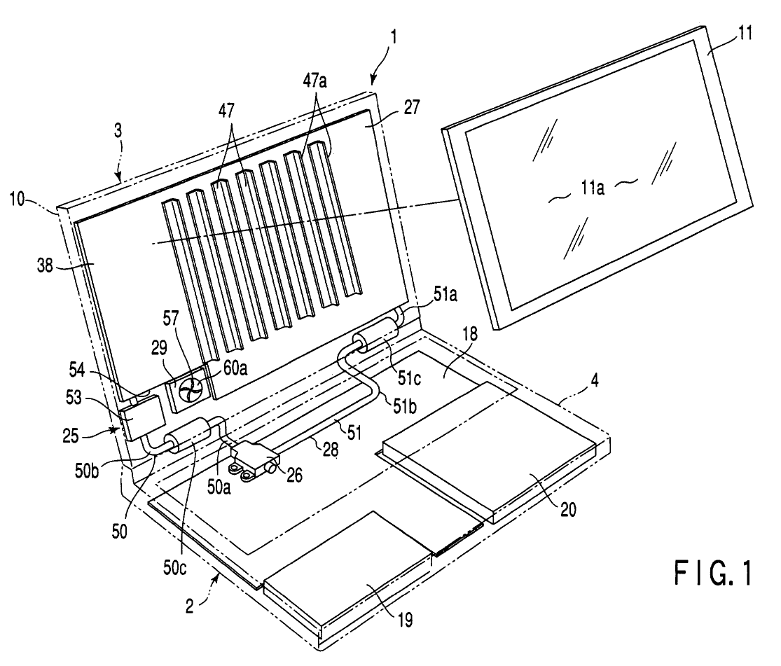

A first embodiment of the present invention will now be described on the basis of FIGS. 1 to 8.

FIGS. 1 to 3 disclose a portable computer 1 as an electronic apparatus. The portable computer 1 is formed of a computer main body 2 and a display unit 3.

The computer main body 2 has a first housing 4 having a flat box shape. The first housing 4 has a bottom wall 4a, top wall 4b, front wall 4c, right and left walls 4d and rear wall 4e. The top wall 4b supports a keyboard 5. Further, the top wall 4b has a display support portion 6 in the rear of the keyboard 5. The display support portion 6 projects upward from the read end portion of the top wall 4b, and extends in the width direction of the first housing 4. The display support portion 6 has a pair of recesses 7a and 7b. The recesses 7a and 7b are spaced from each other in the width direction of the first housing 4.

As shown in FIGS. 1 and 6, the display unit 3 has a second housing 10 having a flat box shape, and a liquid crystal display panel 11 contained in the second housing 10. The second housing 10 has a front wall 13, rear wall 14 and four side walls 15. The liquid crystal display panel 11 is located between the front wall 13 and the real wall 14, and surrounded with the side walls 15. The liquid crystal display panel 11 has a display screen 11a. The display screen 11a is exposed outside the second housing 10 through an opening portion 12 formed at the front wall 13.

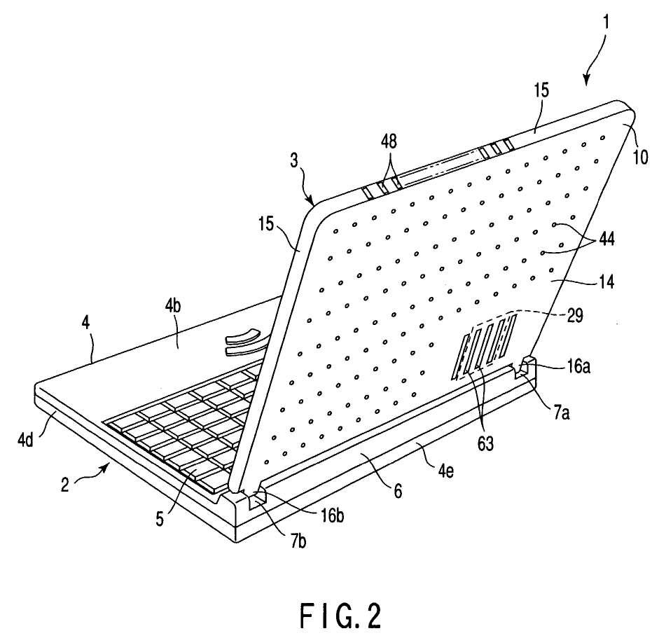

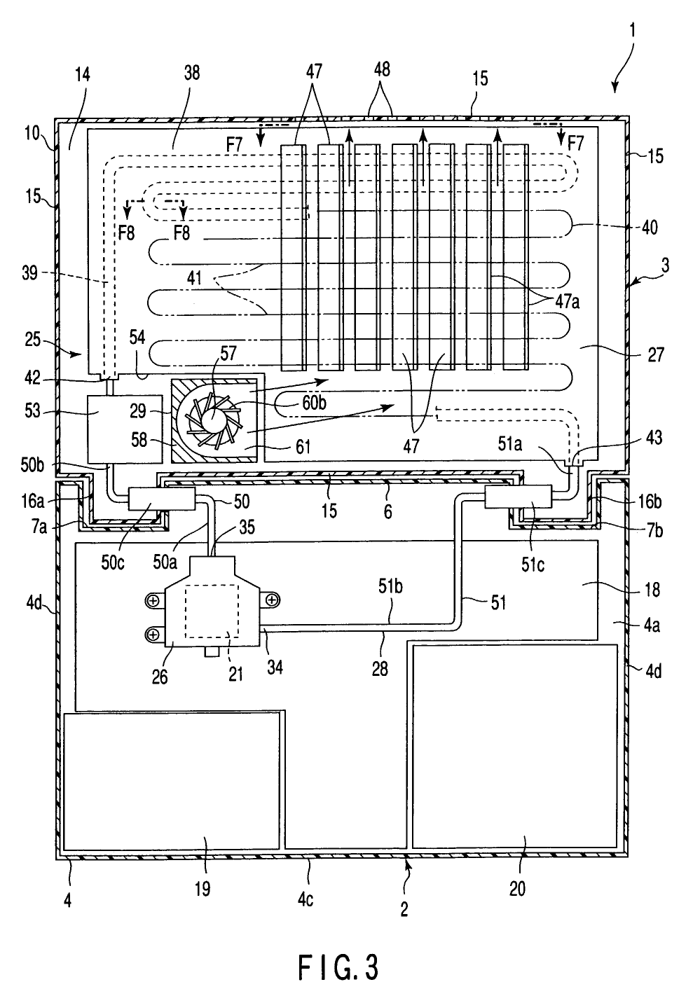

As shown in FIGS. 2 and 3, the second housing 10 has a pair of leg portions 16a and 16b at one end. The leg portions 16a and 16b are hollow, and spaced from each other in the width direction of the second housing 10. The leg portions 16a and 16b are inserted in the recesses 7a and 7b of the first housing 4, respectively, and connected to the first housing 4 via hinge devices (not shown).

Therefore, the display unit 3 is rotatable between a closed position at which the unit lies to cover the keyboard 5 from the above, and an open position at which the unit stands to expose the keyboard 5 and the display screen 11a.

As shown in FIGS. 1 and 3, the first housing 4 contains a printed wiring board 18, hard disk drive 19, and CR-ROM drive 20. The printed wiring board 18, the hard disk drive 19 and the CD-ROM drive 20 are arranged side by side on the bottom wall 4a of the first housing 4.

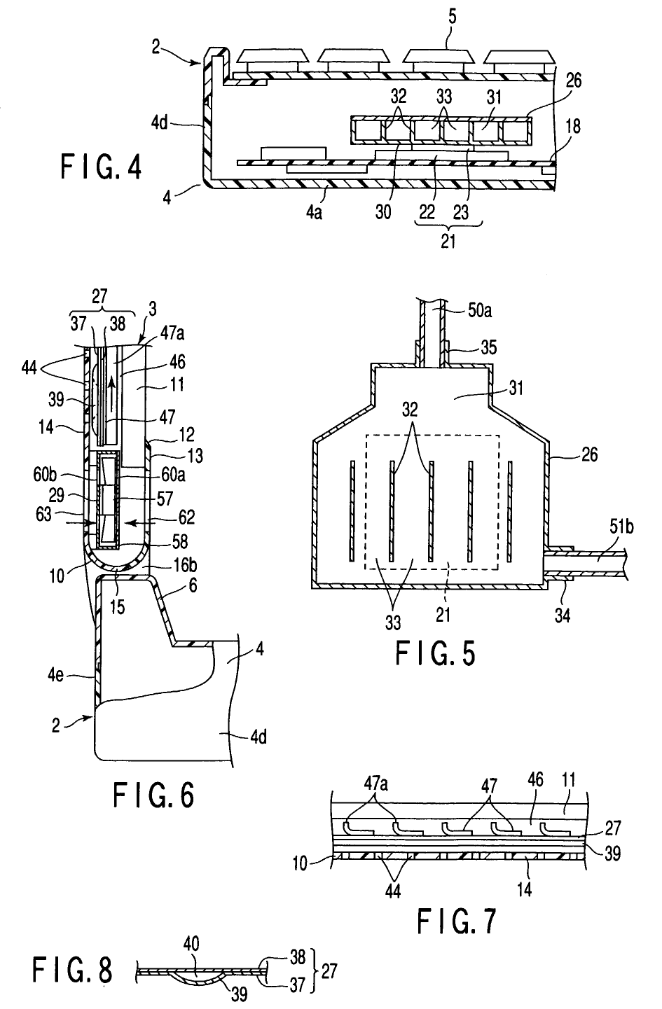

As shown in FIG. 4, a semiconductor package 21 as a heat generating component is mounted on an upper surface of the printed wiring board 18. The semiconductor package 21 forms a microprocessor serving as a brain of the portable computer 1, and is located in a rear portion of the printed wiring board 18. The semiconductor package 21 has a base substrate 22, and an IC chip 23 soldered on an upper surface of the base substrate 22. The IC chip 23 generates a very large amount of heat during operation due to the increased processing speed and functions, and requires cooling to maintain a stable operation.

As shown in FIGS. 1 and 3, the portable computer 1 is equipped with a liquid-cooled cooling unit 25 which cools the semiconductor package 21. The cooling unit 25 has a heat receiving head 26 serving as a heat receiving portion, radiator 27 serving as a heat radiating portion, circulation path 28, and electric fan 29.

The heat receiving head 26 is contained in the first housing 4. As shown best in FIGS. 4 and 5, the heat receiving head 26 has a flat box shape and a size greater than the semiconductor package 21. The heat receiving head 26 is fixed on an upper surface of the printed wiring board 18 by a plurality of screws. A lower surface of the heat receiving head 26 is a flat heat receiving surface 30. The heat receiving surface 30 is thermally connected to the IC chip 23 of the semiconductor package 21.

A refrigerant channel 31 is formed inside the heat receiving head 26. The refrigerant channel 31 is thermally connected to the IC chip 23 with the heat receiving surface 30 intervened therebetween, and divided into a plurality of sections 33 by a plurality of guide walls 32. Further, the heat receiving head 26 has a refrigerant inlet 34 and a refrigerant outlet 35. The refrigerant inlet 34 is located at an upstream end of the refrigerant channel 31. The refrigerant outlet 35 is located at a downstream end of the refrigerant channel 31.

As shown in FIGS. 1, 3 and 6, the radiator 27 is contained in the second housing 31 of the display unit 3. The radiator 27 is intervened between the rear wall 14 of the second housing 10 and the liquid crystal display panel 11. The radiator 27 has a rectangular board shape having a size almost equal to that of the rear wall 14. As shown in FIG. 8, the radiator 27 has a first heat radiating plate 37 and a second heat radiating plate 38. The first and second heat radiating plates 37 and 38 are formed of a metal material having an excellent thermal conductivity, such as aluminum alloy. The first and second heat radiating plates 37 and 38 superposed on each other.

The first heat radiating plate 37 has a bulge portion 39 bulging away from the second heat radiating plate 38. The bulge portion 39 is formed to meander over the whole surface of the first heat radiating plate 37, and has an open end opened to the second heat radiating plate 38. The open end of the bulge portion 39 is closed by the second heat radiating plate 38. Therefore, the bulge portion 39 of the first heat radiating plate 37 forms a refrigerant channel 40 between the second heat radiating plate 38. The refrigerant channel 40 has a plurality of straight tube portions 41 extending in the width direction of the second housing 10. The straight tube portions 41 are arranged in parallel with each other at regular intervals in the height direction of the second housing 10.

The radiator 27 has a refrigerant inlet 42 and a refrigerant outlet 43. The refrigerant inlet 42 communicates with an upstream end of the refrigerant channel 40, and is located in the vicinity of the leg portion 16a on the left side of the second housing 10. The refrigerant outlet 43 communicates with a downstream end of the refrigerant channel 40, and is located in the vicinity of the leg portion 16b on the right side of the second housing 10. Therefore, the refrigerant inlet 42 and the refrigerant outlet 43 are spaced from each other in the width direction of the second housing 10.

The first heat radiating plate 37 of the radiator 27 faces the rear wall 14 of the second housing 10. The rear wall 14 is located behind the radiator 27. A slight space is formed between the rear wall 14 and the bulge portion 39 of the first heat radiating plate 37. The rear wall 14 has a plurality of air holes 44 as shown in FIGS. 2 and 6. The air holes 44 are spread over almost the whole surface of the rear wall 14.

As shown in FIGS. 6 and 7, the second heat radiating plate 38 of the radiator 27 is opposite to the liquid crystal display panel 11. A cooling air passage 46 is formed between the second heat radiating plate 38 and the liquid crystal display panel 11.

A plurality of heat radiating fins 47 are attached to the second heat radiating plate 38. The heat radiating fins 47 are formed of an aluminum plate separate from that of the second heat radiating plate 38, and exposed to the cooling air passage 46. Each of the heat radiating fins 47 has an elongate plate shape, and has at one edge a rising portion 47a which is bent at right angle. The heat radiating fins 47 are bonded to the second heat radiating plate 38 to be thermally connected to the second heat radiating plate 38. The heat radiating fins 47 are arranged in parallel with each other at intervals in the width direction of the display unit 3.

The cooling air passage 46 and the heat radiating fins 47 stand along the display unit 3 when the display unit 3 has been rotated to the open position. In this state, the upper end of each heat radiating fin 47 is opposite to one side wall 15 located at the upper end of the second housing 10. The side wall 15 has a plurality of exhaust slots 48. The exhaust slots 48 are located above a downstream end of the cooling air passage 46, as long as the display unit 3 is located at the open position.

As shown in FIGS. 1 and 3, the circulation path 28 of the cooling unit 25 has a first conduit 50 and a second conduit 51. The first and second conduits 50 and 51 extend over the first housing 4 and the second housing 10.

The first conduit 50 connects the refrigerant outlet 35 of the heat receiving head 26 and the refrigerant inlet 42 of the radiator 27. The first conduit 50 has an upstream portion 50a, a downstream portion 50b and a pipe joint 50c. The upstream portion 50a is connected to the refrigerant outlet 35 of the heat receiving head 26 and contained in the first housing 4. The downstream portion 50b is connected to the refrigerant inlet 42 of the radiator 27, and contained in the left edge portion of the second housing 10. The pipe joint 50c rotatably connects the upstream portion 50a with the downstream portion 50b. The pipe joint 50c pierces into the recess 7a and the leg portion 16a, and is located on the rotation center line of the display unit 3.

The second conduit 51 connects the refrigerant outlet 43 of the radiator 27 with the refrigerant inlet 34 of the heat receiving head 26. The second conduit 51 has an upstream portion 51a, a downstream portion 51b, and a pipe joint 51c. The upstream portion 51a is connected to the refrigerant outlet 43 of the radiator 27, and contained in the right edge portion of the second housing 10. The downstream portion Sib is connected to the refrigerant inlet 34 of the heat receiving head 26, and contained in the first housing 4. The pipe joint Sic rotatably connects the upstream portion 51a with the downstream portion 51b. The pipe joint Sic pierces into the recess 7b and the leg portion 16b, and is located on the rotation center line of the display unit 3.

A coolant as a liquid refrigerant is filled into the refrigerant channel 31 of the heat receiving head 26, the refrigerant channel 40 of the radiator 27, and the circulation path 28. An antifreeze solution is used as the coolant. The antifreeze solution is made by adding an ethylene glycol solution and, if necessary, a corrosion inhibitor, to water, for example.

As shown in FIGS. 1 and 3, the circulation path 28 includes a centrifugal pump 53, for example. The centrifugal pump 53 is provided to circulate the coolant between the heat receiving head 26 and the radiator 27 by force. The centrifugal pump 53 is driven, for example, when the power of the portable computer 1 is turned on, or when the temperature of the semiconductor package 21 has reached a predetermined value.

The centrifugal pump 53 is set in the downstream portion 50b of the first conduit 50, and contained in the second housing 10. The radiator 27 in the second housing 10 has a cut-out portion 54 at an end portion adjacent to the left leg portion 16a. The centrifugal pump 53 is located in the cut-out portion 54. Therefore, the centrifugal pump 53 is disposed between the front wall 13 and the rear wall 14 of the second housing 10 without overlapping the radiator 27.

Further, the centrifugal pump 53 is located at the bottom of the refrigerant channel 40 of the radiator 27, when the display unit 3 has been rotated to the open portion. Therefore, the centrifugal pump 53 is located below the central portion of the display unit 3, as long as the display unit 3 is located in the open position.

As shown in FIGS. 1, 3 and 6, the electric fan 29 of the cooling unit 25 is provided to send cooling air by force to the radiator 27, and contained in the second housing 10. The electric fan 29 is located in the cut-out portion 54 of the radiator 27. Therefore, the electric fan 29 and the centrifugal pump 53 are arranged side by side in the width direction of the second housing, in the cut-out portion 54.

The electric fan 29 has a centrifugal impeller 57, and a fan casing 58 for containing the impeller 57. The impeller 57 is driven by a motor (not shown) when the temperature of the semiconductor package 21 has reached a predetermined value, for example. The fan casing 58 has a flat box shape, and is intervened between the front wall 13 and the rear wall 14 of the second housing 10.

The fan casing 58 has a first inlet port 60a, a second inlet port 60b and an outlet port 61. The first and second inlet ports 60a and 60b are opposite to each other. The impeller 57 is located between the first and second inlet ports 60a and 60b. The first inlet port 60a is opposite to a plurality of first air intakes 62 opened at the front wall 13 of the first housing 4. The second inlet port 60b is opposite to a plurality of second air intakes 63 opened at the rear wall 14 of the first housing 4. The outlet port 61 is opened to the radiator 27.

The electric fan 29 is located under the radiator 27, when the display unit 3 has been rotated to the open position. Therefore, the outlet port 61 of the fan casing 58 is located below the lower ends of the heat radiating fins 47, as long as the display unit 3 is located at the open position.

In such a structure, the IC chip 23 of the semiconductor package 21 generates heat during use of the portable computer 1. The heat of the IC chip 23 is conducted to the heat receiving surface 30 of the heat receiving head 26. Since the heat receiving head 26 has the refrigerant channel 31 filled with the coolant, the coolant absorbs most of the heat conducted to the heat receiving surface 30.

When the temperature of the semiconductor package 21 reaches a predetermined temperature, the centrifugal pump 53 is driven. Thereby, the coolant is transmitted from the heat receiving head 26 to the radiator 27, and the coolant is circulated by force between the refrigerant channel 31 of the heat receiving head 26 and the refrigerant channel 40 of the radiator 27.

To describe it in more detail, the coolant heated by heat exchange in the heat receiving head 26 is guided to the centrifugal pump 53 through the first conduit 50. The coolant pressurized by the centrifugal pump 53 is guided to the radiator 27 through the first conduit 50, and flows through the refrigerant channel 40 bent meanderingly to the refrigerant outlet 43. During this flow, the heat of the IC chip 23 absorbed to the coolant is diffused into the first and second heat radiating plates 37 and 38, and radiated from the surface of the radiator 27 into the second housing 10.

Further, a part of the heat conducted to the radiator 27 is conducted from the second heat radiating plate 38 to the heat radiating fins 47, and radiated from the surface of the heat radiating fins 47 to the cooling air passage 46. Consequently, the heated coolant is cooled by heat exchange in the radiator 27.

When the temperature of the semiconductor package 21 reaches a predetermined value, the electric fan 29 is driven. When the impeller 57 of the electric fan 29 rotates, air outside the display unit 3 is sucked through the air intakes 62 and 63 of the second housing 10 into the inlet ports 60a and 60b of the fan casing 58, as shown by arrows in FIG. 6. The sucked air is exhaled from the external peripheral portions of the impeller 57, and emitted as cooling air from the outlet port 61 of the fan casing 58 to the radiator 27.

Thereby, a flow of cooling air is formed inside the second housing 10. As shown by arrows in FIGS. 3 and 6, the cooling air flows through the cooling air passage 46 upward from the bottom, and cools the radiator 27 by force while it passes between the heat radiating fins 47. Therefore, the heat of the IC chip 23 conducted to the radiator 27 is taken away by the flow of the cooling air. The cooling air heated by heat exchange with the radiator 27 is discharged to the outside of the display unit 3 from the exhaust slots 48 of the second housing 10.

The coolant cooled while passing through the radiator 27 returns to the refrigerant channel 31 of the heat receiving head 26 through the second conduit 51. The coolant absorbs heat of the IC chip 23 again while flowing through the refrigerant channel 31, and then is guided to the radiator 27. By repeating this cycle, heat of the IC chip 23 is radiated to the outside of the portable computer 1 through the display unit 3.

According to such a structure, the radiator 27 contained in the display unit 3 is cooled by force of the cooling air sent from the electric fan 29. Further, since the radiator 27 has a plurality of heat radiating fins 47 exposed to the cooling air passage 46, the area of the radiator 27 contacting cooling air increases. This improves the heat radiating performance of the radiator 27, and enables heat radiation of tens of watts. Therefore, it is possible to efficiently radiate heat of the IC chip 23 transferred to the radiator 27, and to deal with increased heat generation amount of the IC chip 23 without overwork.

In addition, according to the above structure, plural air holes 44 are opened at the rear wall 14 of the second housing 10 opposite to the radiator 27. Therefore, the hot air radiated from the surface of the radiator 27 can be discharged from the air holes 44 to the outside of the second housing 10, and thereby heat hardly remains between the radiator 27 and the rear wall 14. As a result, it is possible to prevent rise in the temperature of the surface of the rear wall 14, and to reduce the effective temperature felt by the user when the user touches the second housing 10.

Further, the electric fan 29 is located under the radiator 27, as long as the display unit 3 is located at the open position. Therefore, the cooling air discharged from the outlet port 61 of the electric fan 29 is guided to the lower end of the cooling air passage 46, and flows inside the second housing 10 to uniformly cover the radiator 27. As a result, the flow of the cooling air in the second housing 10 uniformly runs inside the second housing 10, and it is possible to efficiently cool the radiator 27.

In the meantime, the portable computer 1 having the CD-ROM drive 20 sometimes plays back a music CD in the state where the display unit 3 is located at the closed position. When the display unit 3 is closed as in this state, the front wall 13 of the second housing 10 faces the top wall 4b of the first housing 4 and the keyboard 5, and the first air intakes 62 formed at the front wall 13 are covered by the keyboard 5.

The second housing 10 has the second air intakes 63 formed at the rear wall 14, and in such a case the second air intakes 63 are opposite to the second inlet port 60b of the electric fan 29. Therefore, even when the electric fan 29 is driven in the state where the display unit 3 is closed, the electric fan 29 can suck air outside the display unit 3 through the second air intakes 63. Thus, the cooling air supplied to the radiator 27 is not insufficient, and the radiator 27 can utilize its radiating characteristic to the full.

Further, according to the above structure, the centrifugal pump 53 which circulates the coolant is contained in the second housing 10. Therefore, it is unnecessary to secure a space only for containing the centrifugal pump 53 inside the first housing 4 including, with high density, main components of the portable computer 1, such as the hard disk drive 19 and the CD-ROM drive 20. Therefore, it is possible to reduce the thickness of the first housing 4, and thin the portable computer 1.

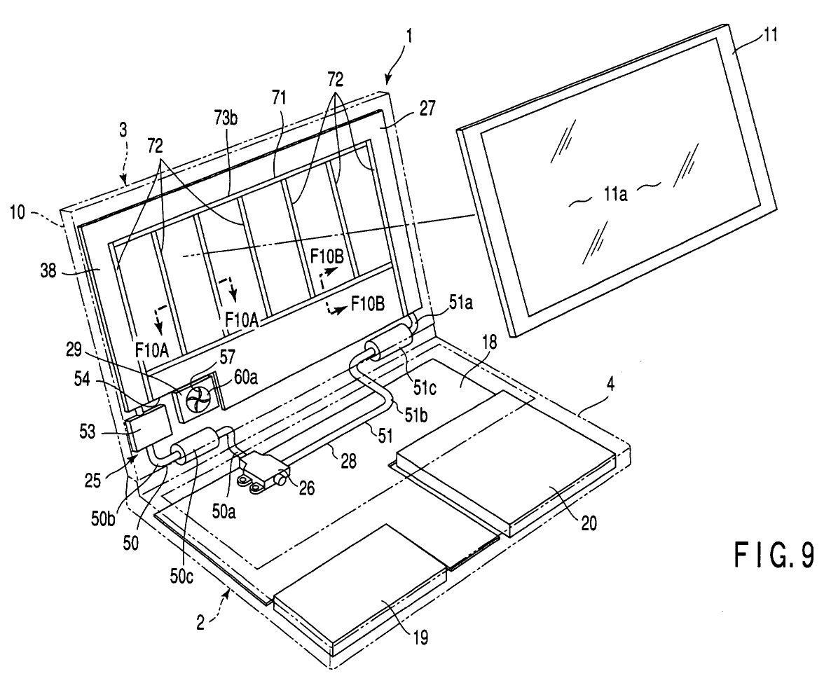

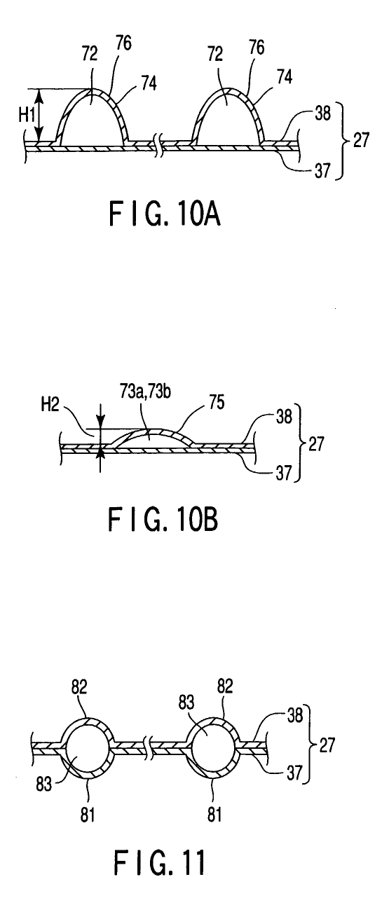

The present invention is not limited to the above first embodiment. FIGS. 9 and 10 disclose a second embodiment of the present invention. The second embodiment is different from the first embodiment in the structure of the radiator 27. The other parts of the structure of the portable computer 1 in the second embodiment are basically the same as those in the first embodiment. Therefore, in the second embodiment, the same elements as those in the first embodiment are denoted by the same reference numerals as in the first embodiment, and their explanations are omitted.

As shown in FIG. 9, the radiator 27 has a refrigerant channel 71 through which a coolant flows. The refrigerant channel 71 is formed of a plurality of first passage portions 72 and a pair of second passage portions 73a and 73b. The first passage portions 72 extend in the height direction of a display unit 3, and are arranged in parallel with each other at intervals in the width direction of the display unit 3. The second passage portions 73a and 73b extend in the width direction of the display unit 3, and are arranged in parallel with each other, with a space, in the height direction of the display unit 3. The first passage portions 72 are located between the second passage portions 73a and 73b. One end of each first passage portion 72 is connected to one second passage portion 73a. The other end of each first passage portion 72 is connected to the other second passage portion 73b.

As shown in FIG. 10A, a second heat radiating plate 38 of the radiator 27 has a plurality of first and second bulge portions 74 and 75. The bulge portions 74 and 75 bulge away from the first heat radiating plate 37. The first bulge portions 74 are provided to form the first passage portions 72, and each has an open end opened to a first heat radiating plate 37. The second bulge portions 75 are provided to form the second passage portions 73a and 73b, and each has an open end opened to the first heat radiating plate 37. The open ends of the first and second bulge portions 74 and 75 are closed by the first heat radiating plate 37. Therefore, the first and second passage portions 72, 73a and 73b are formed between the first heat radiating plate 37 and the second heat radiating plate 38.

As shown in FIGS. 10A and 10B, a bulge height H1 of the first bulge portions 74 is greater than a bulge height H2 of the second bulge portions 75. The taller first bulge portions 74 also function as heat radiating fins 76 projecting to the cooling air passage 46. The heat radiating fins 76 extend in the height direction of the display unit 3, when the display unit 3 has been rotated to the open position.

According to the above structure, the cooling air supplied from an electric fan 29 to the cooling air passage 46 flows between the first bulge portions 74, and cools the radiator 27 during this flow. Therefore, the first bulge portions 74 can be used as heat radiating fins 76, and it is possible to omit dedicated fins. Therefore, it is possible to reduce the number of parts of the radiator 27, and reduce the weight and cost thereof.

Further, since the cooling air flows along the surfaces of the tall first bulge portions 74, the contact area between the radiator 27 and the cooling air increases. Therefore, the cooling air can efficiently remove the heat of the coolant flowing through the refrigerant channel 71, and the heat radiating performance of the radiator 27 is further improved.

FIG. 11 discloses a third embodiment of the present invention.

The third embodiment is different from the first embodiment in the structure of the radiator 27. As shown in FIG. 11, a first heat radiating plate 37 and a second heat radiating plate 38 of a radiator 27 have bulge portions 81 and 82, respectively. The bulge portions 81 of the first heat radiating plate 37 bulge away from the second heat radiating plate 38, and have open ends opened to the second heat radiating plate 38. In the same manner, the bulge portions 82 of the second heat radiating plate 38 bulge away from the first heat radiating plate 37, and have open ends opened to the first heat radiating plate 37. The open ends of the bulge portions 81 meet the respective open ends of the bulge portions 82.

Therefore, the bulge portions 81 and 82 together form refrigerant channels 83 through which the refrigerant flows. The refrigerant channels 83 project to a cooling air passage 46, and between the radiator 27 and a rear wall 14 of a second housing 10.

According to the above structure, the surface area of the radiator 27 increases, and the heat radiating area increases. Therefore, the radiator 27 improves in the heat radiating power, and can efficiently radiate the heat of the IC chip 23.

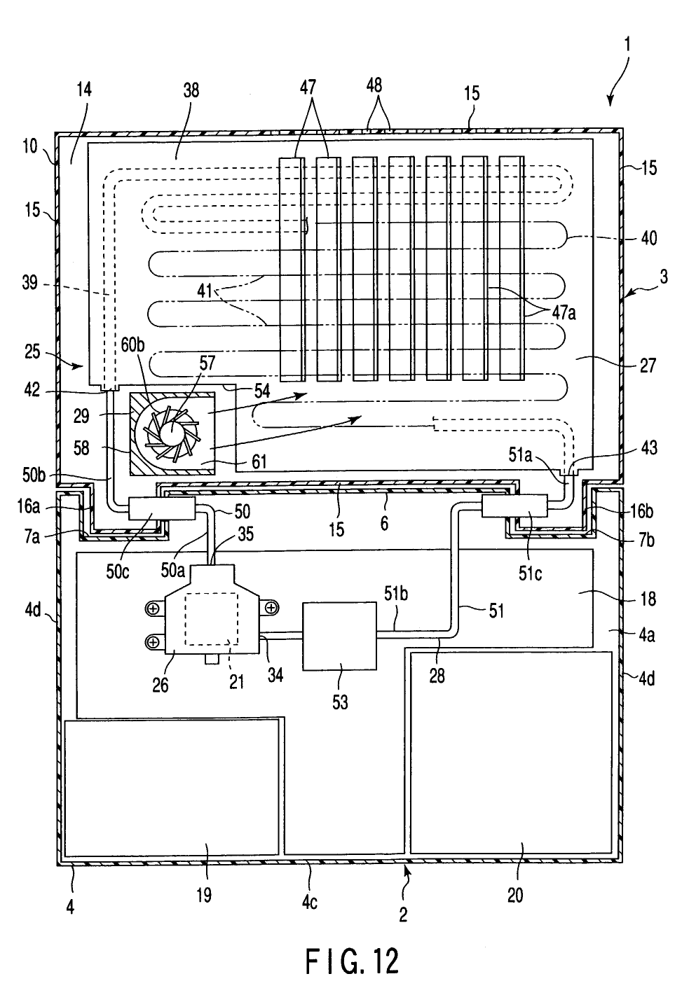

FIG. 12 discloses a fourth embodiment of the present invention.

In the fourth embodiment, a centrifugal pump 53 is located in a downstream portion 51b of a second conduit 51 and contained in a first housing 4. The centrifugal pump 53 is set to send the coolant cooled by a radiator 27 to a heat receiving head 26. The other parts of the structure of a portable computer 1 are the same as those in the first embodiment.

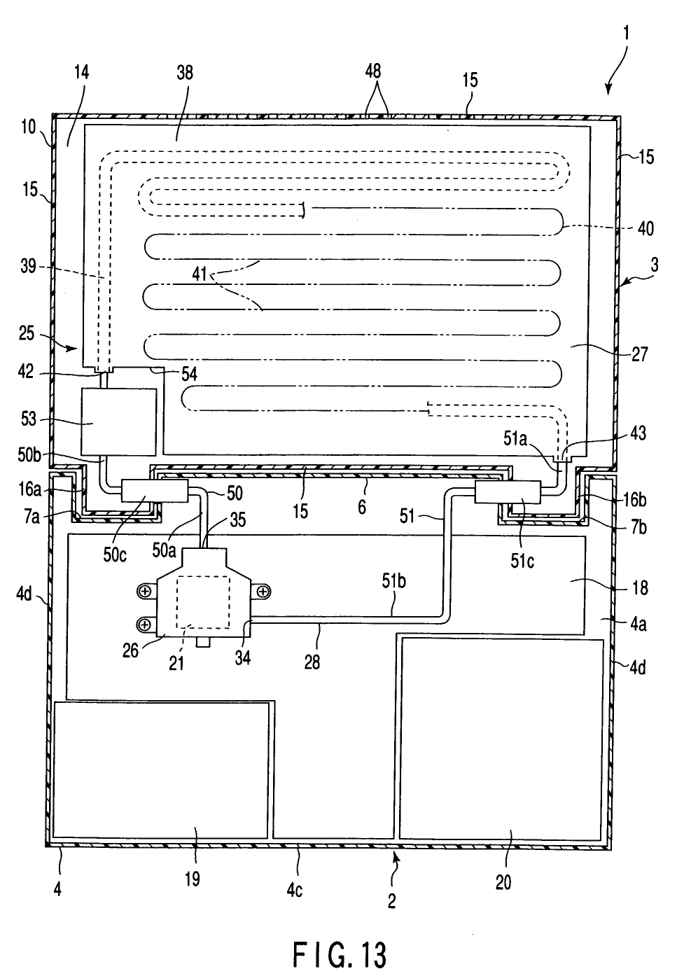

FIG. 13 discloses the fifth embodiment of the present invention.

The fifth embodiment has a structure wherein a centrifugal pump 53 contained in a second housing 10 circulates coolant by force, and a radiator 27 in the second housing 10 is cooled by spontaneous air cooling. The centrifugal pump 53 is located in the vicinity of a leg portion 16a on the left side of the second housing 10, below the central portion of the display unit 3, as seen when the display unit 3 has been rotated to the open position. In the embodiment, the centrifugal pump 53 is located near the bottom portion of a refrigerant channel 40 of the radiator 27.

According to such a structure, the coolant which absorbed heat of an IC chip 23 in a heat receiving head 26 is sent by force of the centrifugal pump 53 to the radiator 27, and flows through the refrigerant channel 40 of the radiator 27. The heat of the IC chip 23 absorbed into the coolant during this flow is diffused into first and second heat radiating plates 37 and 38, and radiated from the surface of the radiator 27 into the second housing 10.

If air bubbles exist in the coolant, air bubbles tends to collect and stay in the highest portion of the coolant passage. In the embodiment, the centrifugal pump 53 which pressurizes the coolant is located near the bottom portion of the refrigerant channel 40 of the radiator 27, when the display unit 3 is located at the open position. Therefore, air bubbles in the coolant hardly remain in the centrifugal pump 53, and it is possible to prevent the centrifugal pump 53 from being damaged due to cavitation.

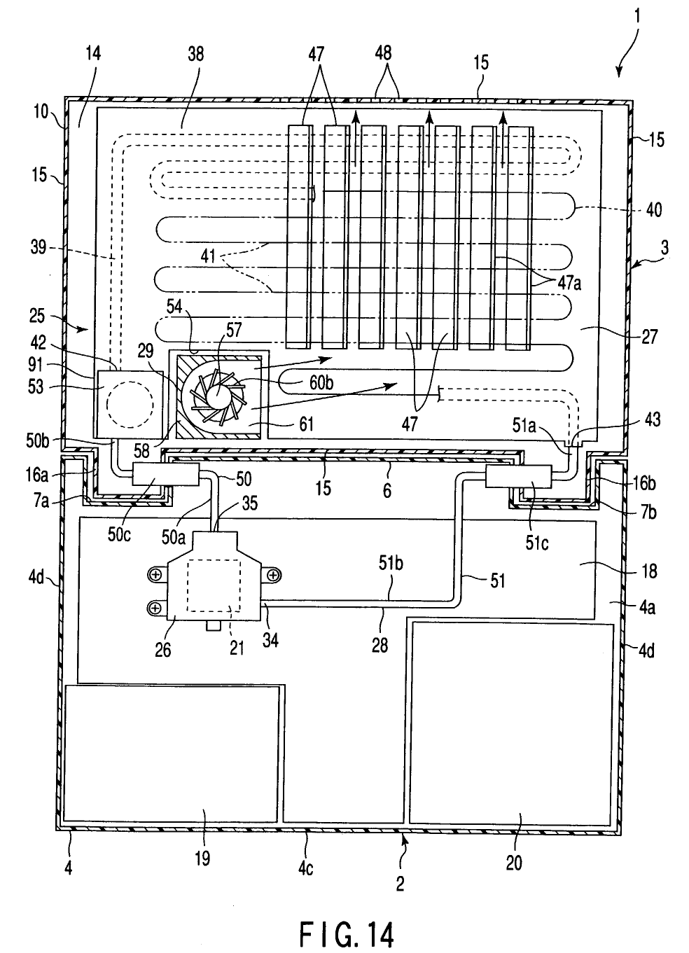

FIG. 14 discloses a sixth embodiment of the present invention.

In the sixth embodiment, a radiator 27 and a centrifugal pump 53 form a unitary one-piece structure. The other parts of the structure of a portable computer 1 in the embodiment are basically the same as those in the first embodiment.

As shown in FIG. 14, the radiator 27 has a pump support portion 91. The pump support portion 91 is located adjacent to an electric fan 29, and is located below a refrigerant inlet 42 of a refrigerant channel 40 when a display unit 3 has been rotated to the open position. The centrifugal pump 53 is put in the pump support portion 91. The inlet port of the centrifugal pump 53 is connected to a downstream portion 50b of the first conduit 50. The outlet port of the centrifugal pump 53 is directly connected to the refrigerant inlet 42 of the radiator 27.

According to such a structure, since the centrifugal pump 53 is put in the radiator 27, the radiator 27 and the centrifugal pump 53 can be contained together in a second housing 10 of the display unit 3. This reduces the number of the work steps in comparison with the case of containing the radiator 27 and the centrifugal pump 53 individually in a second housing 10, and simplifies assembling of the display unit 3.

Further, since the outlet port of the centrifugal pump 53 is directly connected to the refrigerant inlet 42 of the radiator 27, it is unnecessary to provide a pipe to connect the outlet port of the centrifugal pump 53 with the refrigerant inlet 42. This reduces the number of the parts as a matter of course, and reduce the number of work steps for mounting the radiator 27 in the display unit 3, and thereby the manufacturing cost of the portable computer 1 can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a main body having a heat generating component;
a heat receiving portion thermally connected to the heat generating component;
a display unit supported by the main body and having a display panel;
a heat radiating portion contained in the display unit;
a circulation path which circulates a liquid refrigerant between the heat receiving portion and the heat radiating portion; and
a fan contained in the display unit and supplying cooling air to the heat radiating portion.

2. An electronic apparatus according to claim 1, wherein the heat radiating portion is opposite to the display panel inside the display unit, and the fan supplies cooling air between the heat radiating portion and the display panel.

3. An electronic apparatus according to claim 1, wherein the display unit is rotatable between a closed position at which the display unit lies to cover the main body and an open position at which the display unit stands with respect to the main body, and the fan is located under the heat radiating portion when the display unit has been rotated to the open position.

4. An electronic apparatus according to claim 1, wherein the display unit comprises a housing containing the display panel and the fan, the housing having a front wall and a rear wall facing each other with the display panel intervened therebetween, the front wall and the rear wall each having air intakes, the fan having a fan casing containing an impeller, and the fan casing having a first inlet port communicating with the air intakes of the front wall, a second inlet port communicating with the air intakes of the rear wall, and an outlet port which supplies the cooling air exhaled from an external peripheral portion of the impeller to the heat radiating portion.

5. An electronic apparatus according to claim 4, wherein the heat radiating portion intervenes between the rear wall of the housing and the display panel, and the rear wall has a plurality of air holes.

6. An electronic apparatus according to claim 1, wherein the heat radiating portion has a plurality of heat radiating fins.

7. An electronic apparatus according to claim 6, wherein the heat radiating fins are arranged at intervals in the width direction of the display unit, and stand along the display unit when the display unit has been rotated to the open position.

8. An electronic apparatus according to claim 6, wherein the heat radiating fins are formed of a heat conductive material separate from that of the heat radiating portion, and thermally connected to the heat radiating portion.

9. An electronic apparatus according to claim 1, wherein the heat radiating portion has a first heat radiating plate, and a second heat radiating plate superposed on the first heat radiating plate, and a refrigerant channel is formed between the first heat radiating plate and the second heat radiating plate.

10. An electronic apparatus according to claim 9, wherein at least one of the first and second heat radiating plates has a plurality of bulge portions bulging to the outside of the heat radiating portion, the bulge portions form the refrigerant channel and also function as the heat radiating fins.

11. An electronic apparatus according to claim 1, wherein the circulation path includes a pump which pressurizes and sends the refrigerant, the pump contained in the display unit.

12. An electronic apparatus, comprising:
a main body having a heat generating component;
a heat receiving portion contained in the main body and thermally connected to the heat generating component;
a display unit supported by the main body:
a heat radiating portion contained in the display unit;
a circulation path through which a liquid refrigerant flows, the circulation path connecting the heat receiving portion and the heat radiating portion;
a pump contained in the display unit, the pump located in the circulation path and circulating the refrigerant between the heat receiving portion and the heat radiating portion; and
a fan contained in the display unit and supplying cooling air to the heat radiating portion.

13. An electronic apparatus according to claim 12, wherein the heat radiating portion has a plurality of fins.

14. An electronic apparatus according to claim 12, wherein the display unit is rotatable between a closed position at which the display unit lies to cover the main body and an open position at which the display unit stands with respect to the main body, and the pump is located below the central portion of the display unit, when the display unit has been rotated to the open position.

15. An electronic apparatus according to claim 12, wherein the pump and the fan are arranged side by side in the width direction of the display unit.

16. An electronic apparatus according to claim 12, wherein the display unit includes a display panel and a housing containing the display panel, the housing having a front wall and a rear wall facing each other with the display panel intervened therebetween, the heat radiating portion intervened between the rear wall of the housing and the display panel, the pump and the fan arranged between the front wall and the rear wall.

17. An electronic apparatus, comprising:
a main body having a heat generating component;
a heat receiving portion contained in the main body and thermally connected to the heat generating component;
a display unit supported by the main body, the display unit having a display panel and a housing containing the display panel, the housing having a rear wall located behind the display panel;
a heat radiating portion contained in the display unit and intervened between the display panel and the rear wall of the housing;
a circulation path extending over the main body and the display unit, the circulation path circulating a liquid refrigerant between the heat receiving portion and the heat radiating portion;
a cooling air passage formed inside the housing of the display unit, the cooling air passage located between the heat radiating portion and the display panel; and
a fan contained in the display unit and supplying cooling air to the cooling air passage.

18. An electronic apparatus according to claim 17, wherein the heat radiating portion has a plurality of heat radiating fins projecting to the cooling air passage.

19. An electronic apparatus according to claim 17, wherein the housing of the display unit has a plurality of exhaust ports, the exhaust ports located downstream the cooling air passage.

20. An electronic apparatus according to claim 19, wherein the display unit is rotatable between a closed position at which the display unit lies to cover the main body and an open position at which the display unit stands with respect to the main body and, when the display unit has been rotated to the open position, the fan is located under the heat radiating portion and the exhaust ports are located above the heat radiating portion.
